(19) United States
(12) Patent Application Publication
(10) Pub. No.: US 2023/0404299 A1
(43) Pub. Date: Dec. 21, 2023

(54) Dual Temperature Blanket Device

(71) Applicant: Thea Klingberg, Las Vegas, NV (US)

(72) Inventor: Thea Klingberg, Las Vegas, NV (US)

(21) Appl. No.: 17/903,185

(22) Filed: Sep. 6, 2022

Related U.S. Application Data
(60) Provisional application No. 63/346,353, filed on May 27, 2022.

(51) Int. Cl. A47G 9/02

(52) U.S. Cl. CPC A47G 9/0215; A47G 2009/001; A47G 9/0223

(57) ABSTRACT

The present invention relates to a dual temperature blanket device primarily comprised of a first panel, a second panel connected to the first panel, and a third panel connected to the first panel opposite the second panel. Further, the second and third panels may be made from cooling or warming materials. In another embodiment the second and third panels may be comprised of heating or cooling elements to further heat or cool the user. In one embodiment, the device is further comprised of at least one fold that allows a user to cover themselves up with their panel. The fold may be further comprised of a fastener that allows a user to detach the panels and wash them, replace damaged panels, or exchange panels. The device thus allows users to sleep in their preferred temperatures.

### CROSS-REFERENCE TO RELATED APPLICATION

The present application claims priority to, and the benefit of, U.S. Provisional Application No. 63/346,353, which was filed on May 27, 2022, and is incorporated herein by reference in its entirety.

### FIELD OF THE INVENTION

The present invention relates generally to the field of blankets. More specifically, the present invention relates to a dual temperature blanket device primarily comprised of a first panel, a second panel connected to the first panel, and a third panel connected to the first panel opposite the second panel. The second panel is manufactured from a cooling material that provides a user a way to sleep in colder temperatures. The third panel is manufactured from a warming material that allows a user to sleep comfortably in the warmth. The second and third panels may further be comprised of heating and cooling elements. Accordingly, the present disclosure makes specific reference thereto. Nonetheless, it is to be appreciated that aspects of the present invention are also equally applicable to other like applications, devices, and methods of manufacture.

### BACKGROUND

By way of background, when individuals sleep with partners, they may have difficulty getting a good night of sleep. One individual may enjoy sleeping in a cold environment, while their partner may enjoy sleeping in a warm environment. However, it is nearly impossible to accomplish both sleeping temperature environments with traditional blankets. When one partner is uncomfortable, they may toss and turn throughout the night causing neither individual to get the proper amount of sleep. This can lead to arguments in the relationship or force the partners to sleep in different beds. When partners must sleep with separate blankets, or in separate beds, there is a loss of intimacy in the relationship which can have a long-lasting negative impact on the relationship.

Therefore, there exists a long-felt need in the art for an improved blanket. Further, there exists a long-felt need in the art for a dual temperature blanket device that provides individuals with a device to maintain optimal temperatures while asleep. There also exists a long-felt need in the art for a dual temperature blanket device that allows one partner to sleep in a cooling blanket, while allowing the other partner to sleep in a heating blanket. There also exists a long-felt need in the art for a dual temperature blanket device that can improve users' sleep while not diminishing the intimacy in a relationship. There also exists a long-felt need in the art for a blanket that allows individuals to sleep within their temperature preferences without affecting their partner.

The subject matter disclosed and claimed herein, in one embodiment thereof, comprises a dual temperature blanket device. The device is primarily comprised of a first panel, a second panel connected to the first panel, and a third panel connected to the first panel opposite the second panel. In various embodiments, each panel may be comprised of differing material and/or construction such that one panel provides a cooling effect, and another panel provides a heating effect.

In this manner, the dual temperature blanket device of the present invention accomplishes all of the foregoing objectives and provides a novel dual temperature blanket that allows partners to sleep comfortably in their preferred temperature environment. Further, if one user prefers to sleep in the cold and one prefers to sleep in warmth, the device allows both users to sleep in their preferred climate while not removing the intimacy of sharing a bed and blanket with one another.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dual temperature blanket device. The device is primarily comprised of a first panel, a second panel connected to the first panel, and a third panel connected to the first panel opposite the second panel. The device is comprised of an interior surface and an exterior surface on all three panels. The device is also comprised of a divider located on the first panel to prevent couples from rolling into each other throughout the night or rolling into the other user's panel.

Further, the device is comprised of at least one fold that allows a user to pull their panel on top of them during sleep. In one embodiment, the folds are further comprised of at least one fastener. The fasteners allow for the panels to be detached from each other, thereby allowing users to interchange panels or clean them more easily.

In one embodiment, the interior surface on the second panel is manufactured from a cooling material. In another embodiment, the second panel is comprised of a cooling element that can help to create a colder environment for the user. The cooling element may be powered by at least one battery or by a power cord.

In another embodiment, the interior surface of the third panel is manufactured from a warmer material. In another embodiment, the third panel is comprised of a heating element that can further heat the panel. The heating element may be powered by either at least one battery or a power cord. The heating and cooling elements may be operated via at least one remote.

In one embodiment, the third panel and second panel are connected to close the users into the device via at least one fastener. The fasteners allow for the two panels to be attached to one another and held in place so a user does not knock their panel off of them in the middle of the night.

Accordingly, the dual temperature blanket device of the present invention is particularly advantageous as it provides users with a novel way for two people to both sleep comfortably in different temperatures. Further, it allows one user to sleep in the cold, and another to sleep in the warmth without having to sleep in separate beds, or use separate blankets. In this manner, the dual temperature blanket device overcomes the limitations of existing blankets known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a dual temperature blanket device of the present invention while partially folded over in accordance with the disclosed architecture; and

FIG. 2 illustrates a perspective view of one potential embodiment of a dual temperature blanket device of the present invention while being used by two users in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved blanket. Further, there exists a long-felt need in the art for a dual temperature blanket device that provides individuals with a means to maintain optimal temperatures while asleep. There also exists a long-felt need in the art for a dual temperature blanket device that allows one partner to sleep in a cooling blanket, while allowing the other partner to sleep in a heating blanket. There also exists a long-felt need in the art for a dual temperature blanket device that can improve users' sleep while not diminishing the intimacy in a relationship. There also exists a long-felt need in the art for a blanket that allows individuals to sleep with their temperature preferences without affecting their partner.

The present invention, in one exemplary embodiment, is comprised of a dual temperature blanket device. The device is primarily comprised of a first panel, a second panel connected to the first panel, and a third panel connected to the first panel opposite the second panel. Each panel is further comprised of an interior surface and an exterior surface. In one embodiment, the first panel is further comprised of a divider that separates users, such that one user does not roll onto another user's panel. The device is further comprised of at least one fold to allow a user to be wrapped in their panel of preferred temperature. In one embodiment, the device is comprised of at least one fastener located on the folds that allow the folds to be attached/detached so the user can change the hot/cold areas.

In one embodiment, the device may have a cooling element on one side and a heating element on the other side. The heating and cooling elements allow a user to be able to change the amount of heat or cold they are receiving. Further, the heating and cooling elements are controlled by at least one remote.

In another embodiment, the panels are manufactured from either warming materials or cooling materials. In this embodiment, the levels of hot or cold cannot be changed.

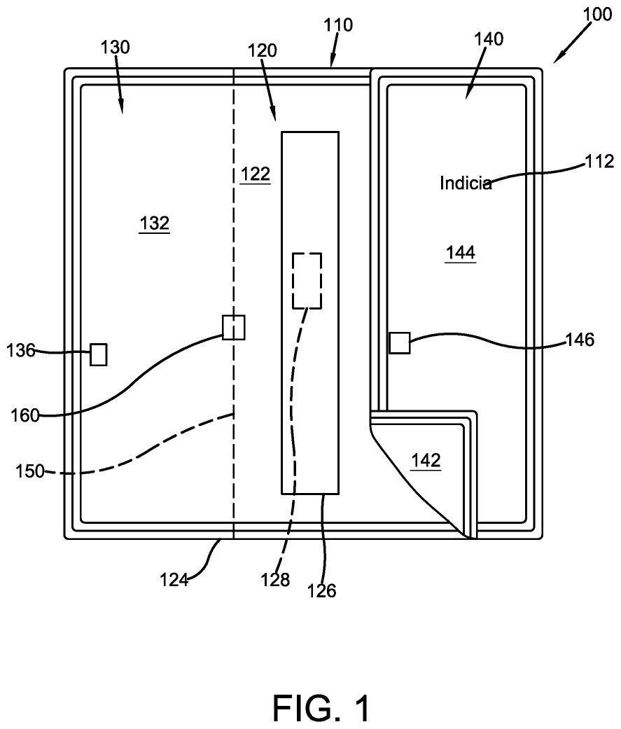

Referring initially to the drawings, FIG. 1 illustrates a perspective view of one potential embodiment of a dual temperature blanket device 100 of the present invention while partially folded over in accordance with the disclosed architecture. The device 100 is primarily comprised of a first panel 120, a second panel 130 connected to the first panel, and a third panel 140 connected to the first panel opposite the second panel 130.

The body 110 is comprised of a first panel 120, comprised of an interior surface 122 and an exterior surface 124. In one embodiment, the interior surface 122 and the exterior surface 124 are made from the same material. In a differing embodiment, the interior surface 122 and exterior surface 124 are made from two different materials. There are a plurality of materials that may be used such as, but not limited to, cotton, polyester, fleece, wool, acrylic, fur, bamboo, down, etc. In one embodiment, the body 110 may be waterproof. In another embodiment, the body 110 may be hypoallergenic. In yet another embodiment, the body 110 may be a weighted blanket material.

In one embodiment, the first panel 120 may be comprised of at least one divider 126 located on the interior surface 122. The divider 126 prevents one user from rolling onto the other user's side of the device 100 during sleep. Further, the divider 126 allows each user to sleep on their respective side of the device 100 throughout the night, leading to a better night of sleep. The divider 126 may be weighted and may be manufactured from a plurality of materials such as, but not limited to, foam, cotton, plastic, sponge, rubber, cloth, down, etc. The divider 126 is further attached to the interior surface 122 of the first panel 120 via at least one fastener 128. The fastener 128 may be located on the divider 126 with at least one reciprocating fastener 128 located on the interior surface 122. The fasteners 126,128 prevent the divider 126 from moving throughout the night when a user bumps the divider 126. The fasteners 126,128 that may be used are any suitable fastener known in the art such as, but not limited to, hook and loop, magnet, zipper, snap-button, etc.

The device 100 is also comprised of a second panel 130 and a third panel 140. In the preferred embodiment, the second panel 130 and the third panel 140 are made from different materials, wherein the second panel 130 is made from a cooling fabric and the third panel 140 is made from a warming fabric.

The second panel 130 is further comprised of an interior surface 132 and an exterior surface 134. In one embodiment, the interior surface 132 is comprised of a cooling material, while the exterior surface 134 is manufactured from a warm material. As a result, the panel 130 is reversible. In another embodiment, the exterior surface 134 is made of a normal blanket material like the first panel 120 while the interior surface 132 is manufactured from a cooling material. In yet another embodiment, the interior surface 132 and exterior surface 134 are both manufactured from the same cooling material. The cooling material that may be used is any cooling material known in the art such as, but not limited to, polyester, acrylic, bamboo, etc.

In a differing embodiment, the second panel 130 may be comprised of at least one cooling element 180. The cooling element 180 may be any cooling element known in the art such as, but not limited to, a fan with at least one cooling level, openings, gel packs, etc. In one embodiment, the cooling element 180 may be powered by at least one battery 182. The battery 182 can be in the form of an alkaline, nickel-cadmium, nickel-metal hydride battery, etc., such as any 3V-12-volt DC battery 182 or other conventional battery 182 such as A, AA, AAA, etc., that supplies power to the cooling element 180. Throughout this specification the terms “battery” and “batteries” may be used interchangeably to refer to one or more wet or dry cells or batteries 182 of cells in which chemical energy is converted into electricity and used as a source of DC power. References to recharging or replacing batteries 182 may refer to recharging or replacing individual cells, individual batteries 182 of cells, or a package of multiple battery cells as is appropriate for any given battery 182 technology that may be used. In another embodiment, the battery 182 may receive power via a power cord 184. The cooling element 180 further may be controlled via at least one remote 186. The remote 186 may have various capabilities such as but not limited to changing the level of cold air output, turning off and on the cooling element 180, pausing the cooling element 180, etc., via at least one button 188. Further, the remote 186 may be any remote known in the art. The cooling element 180, such as removable gel packs, may be manually removed from the device 100 and stored in the freezer during the day to insure they are cold when placed into the device 100.

The third panel 140 is comprised of an interior surface 142 and an exterior surface 144. In one embodiment, the interior surface 142 is comprised of a warming material while the exterior surface 144 is manufactured from a cooling material. As a result, the panel 140 is reversible. In another embodiment, the exterior surface 144 is made of a normal blanket material like the first panel 120, while the interior surface 142 may be manufactured from a warming material. In yet another embodiment, the interior surface 142 and exterior surface 144 are both manufactured from the same warming material. The warm material may be manufactured from any warm material known in the art such as, but not limited to, wool, artificial or natural fur, flannel, etc.

In a differing embodiment, the third panel 140 may be comprised of at least one heating element 170. The heating element 170 may be any heating element known in the art such as, but not limited to, heated coils, heated wires, hot air blower with at least one heating level, etc. In one embodiment, the heating element 170 may be powered by at least one battery 172. The battery 172 can be in the form of an alkaline, nickel-cadmium, nickel-metal hydride battery, etc., such as any 3V-12-volt DC battery 172 or other conventional battery 172 such as A, AA, AAA, etc., that supplies power to the heating element 170. Throughout this specification the terms “battery” and “batteries” may be used interchangeably to refer to one or more wet or dry cells or batteries 172 of cells in which chemical energy is converted into electricity and used as a source of DC power. References to recharging or replacing batteries 172 may refer to recharging or replacing individual cells, individual batteries 172 of cells, or a package of multiple battery cells as is appropriate for any given battery 172 technology that may be used. In another embodiment, the heating element 170 may be powered via power cord 174. The heating element 170 further may be controlled via at least one remote 176. The remote 176 may have various capabilities such as, but not limited to, changing the level of heat output, turning off and on the heating element 170, pausing the heating element 170, etc., via at least one button 178. Further, the remote 176 may be any remote known in the art.

The device 100 is also comprised of at least one fold 150. The fold 150 allows the user to pull their respective panel 130,140 on top of them. In one embodiment, the folds 150 may attach the panels 120, 130, 140 to each other via at least one fastener 160 located on the fold 150. The fasteners 160 located on the folds 150 further allow for the panels 130, 140 to be attached and detached from the first panel 120. The detachable panels 120, 130, 140 allow a user to wash the device 100 (or sections of the device) more conveniently. The fastener 160 may further allow users to change the second panel 130 and third panel 140 out with new panels if they were to ever break or become worn. There are a plurality of fasteners 160 that may be used such as, but not limited to, zipper, hook and loop, snap button, magnetic, etc.

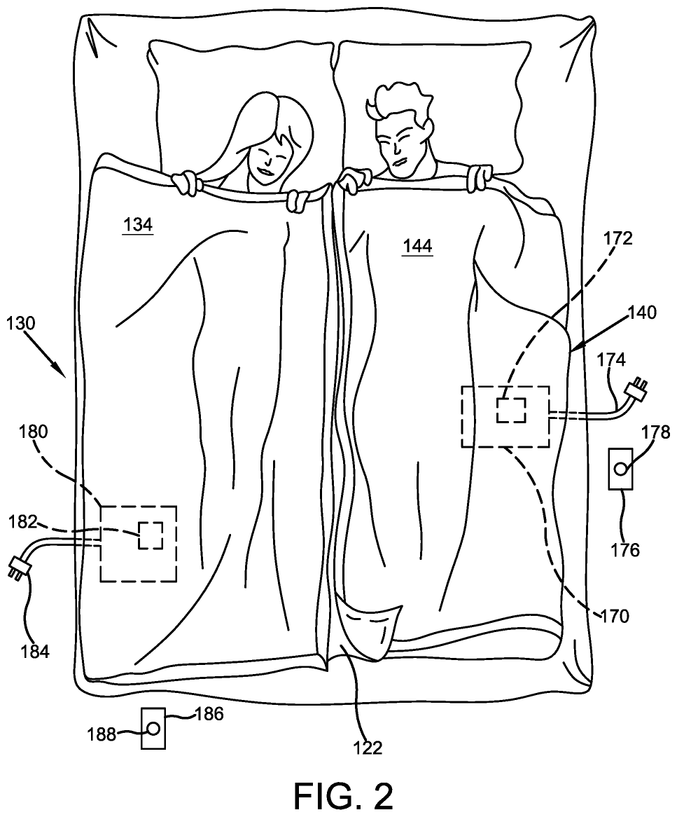

FIG. 2 illustrates a perspective view of one potential embodiment of a dual temperature blanket device 100 of the present invention while being used by two users in accordance with the disclosed architecture. The device 100 further may be comprised of at least one indicia 112 located on the external surfaces 142, 132 that indicate what panel 130, 140 is the warm side, and which is the cold side. There may be a plurality of indica 112 that is used such as, but not limited to, symbols, words, numbers, images, etc.

In one embodiment, the device 100 may be comprised of at least one fastener 136 located on the interior 132 or exterior 134 surface of the second panel 130. Further, the device 100 may be comprised of at least one reciprocating fastener 146 located on the interior surface 142 or exterior surface 144 of the third panel 140. These fasteners 136, 146 function to secure the two panels 130, 140 when users are inside the device 100. The fasteners 136, 146 prevent users from knocking the panels 140, 130 off of them while they are sleeping. There are a plurality of fasteners 136, 146 that may be used such as, but not limited to, a zipper, hook and loop, snap button, magnetic, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dual temperature blanket device” and “device” are interchangeable and refer to the dual temperature blanket device 100 of the present invention.

Notwithstanding the foregoing, the dual temperature blanket device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dual temperature blanket device 100 as shown in the FIGS. are for illustrative purposes only, and that many other sizes and shapes of the dual temperature blanket device 100 are well within the scope of the present disclosure. Although the dimensions of the dual temperature blanket device 100 are important design parameters for user convenience, the dual temperature blanket device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dual temperature blanket device comprising:
a first panel;
a second panel comprised of a first material attached to the first panel; and
a third panel comprised of a second material attached to the first panel.

2. The dual temperature blanket device of claim 1, wherein each of the first panel, the second panel, and the third panel are comprised of a waterproof material.

3. The dual temperature blanket device of claim 1, wherein each of the first panel, the second panel, and the third panel are comprised of a hypoallergenic material.

4. The dual temperature blanket device of claim 1, wherein each of the first panel, the second panel, and the third panel further comprise a weighted material.

5. The dual temperature blanket device of claim 1, wherein the first material is a cooling material.

6. The dual temperature blanket device of claim 5, wherein the first material is comprised of a polyester, an acrylic, or a bamboo material.

7. The dual temperature blanket device of claim 1, wherein the second material is a warming material.

8. The dual temperature blanket device of claim 7, wherein the second material is comprised of a wool, an artificial fur, a natural fur, or a flannel material.

9. A dual temperature blanket device comprising:
a first panel;
a second panel comprised of a cooling material attached to the first panel via a first fastener; and
a third panel comprised of a warming material attached to the first panel via a second fastener.

10. The dual temperature blanket device of claim 9, wherein an interior surface of the second panel is comprised of the cooling material and an exterior surface of the second panel is comprised of a material other than the cooling material.

11. The dual temperature blanket device of claim 9, wherein an interior surface of the third panel is comprised of the warming material and an exterior surface of the third panel is comprised of a material other than the warming material.

12. A dual temperature blanket device comprising:
a first panel;
a second panel attached to the first panel via a first fastener, wherein the second panel is comprised of a cooling material and a cooling element; and
a third panel attached to the first panel via a second fastener, wherein the third panel is comprised of a warming material and a heating element.

13. The dual temperature blanket device of claim 12, wherein the first panel is comprised of a divider.

14. The dual temperature blanket device of claim 12, wherein the divider is comprised of a foam material.

15. The dual temperature blanket device of claim 13, wherein the divider attaches to the first panel via a third fastener.

16. The dual temperature blanket device of claim 12, wherein the cooling element is a fan, an opening, or a gel pack.

17. The dual temperature blanket device of claim 16, wherein the fan is controlled by a first remote.

18. The dual temperature blanket device of claim 12, wherein the heating element is a heated coil, a heated wire, or a hot hair blower.

19. The dual temperature blanket device of claim 18, wherein the heating element is powered by a battery.

20. The dual temperature blanket device of claim 19, wherein the heating element is controlled by a second remote.
